(19) United States
(12) Patent Application Publication
(10) Pub. No.: US 2007/0268812 A1
(43) Pub. Date: Nov. 22, 2007

(54) METHOD OF CONFIGURING WIRELESS RESOURCE FOR EFFECTIVE AND EFFICIENT TRANSMISSION IN A WIRELESS COMMUNICATION SYSTEM

(75) Inventors: Young C. Yoon, San Diego, CA (US); Li-Hsiang Sun, San Diego, CA (US); Sang G. Kim, San Diego, CA (US); Suk Woo Lee, San Diego, CA (US)

Correspondence Address: LEE, HONG, DEGERMAN, KANG & SCHMADEKA, 660 S. FIGUEROA STREET, Suite 2300, LOS ANGELES, CA, 90017, US

(73) Assignee: LG Electronics Inc.

(21) Appl. No.: 11/751,510

(22) Filed: May 21, 2007

Related U.S. Application Data
(60) Provisional application No. 60/801,702, filed on May 19, 2006.
(60) Provisional application No. 60/802,861, filed on May 22, 2006.
(60) Provisional application No. 60/820,085, filed on Jul. 21, 2006.

(51) Int. Cl. H04J 11/00

(52) U.S. Cl. 370/203

(57) ABSTRACT

A method of transmitting a data packet in a orthogonal frequency division multiplexing (OFDM) system is disclosed. More specifically, the method includes receiving feedback information from an access terminal (AT), configuring the data packet for indoor environment or outdoor environment with at least one of variable duration of cyclic prefix (CP) and of data portion and variable number of CPs based on the feedback information, and transmitting the configured data packet to the AT.

This application claims the benefit of U.S. Provisional Application No. 60/801,702, filed on May 19, 2006, U.S. Provisional Application No. 60/802,861, filed on May 22, 2006, and U.S. Provisional Application No. 60/820,085, filed on Jul. 21, 2006, which are hereby incorporated by reference.

### BACKGROUND OF THE INVENTION

1. Field of the Invention

The present invention relates to a method of transmitting data, and more particularly, to a method of configuring wireless resource for effective and efficient transmission in a wireless communication system.

2. Discussion of the Related Art

In the world of cellular telecommunications, those skilled in the art often use the terms 1G, 2G, and 3G. The terms refer to the generation of the cellular technology used. 1G refers to the first generation, 2G to the second generation, and 3G to the third generation.

1G refers to the analog phone system, known as an AMPS (Advanced Mobile Phone Service) phone systems. 2G is commonly used to refer to the digital cellular systems that are prevalent throughout the world, and include CDMAOne, Global System for Mobile communications (GSM), and Time Division Multiple Access (TDMA). 2G systems can support a greater number of users in a dense area than can 1G systems.

3G commonly refers to the digital cellular systems currently being deployed. These 3G communication systems are conceptually similar to each other with some significant differences.

In today's wireless communication system, a user (or a mobile) can freely roam about while enjoying uninterrupted service. To this end, it is important to devise schemes and techniques that improve efficiency as well as effectiveness of service of a communication system under the all sorts of different conditions and environments of the wireless system. To address various conditions and environments and to enhance communication service, various methods, including reducing transmission of unnecessary signal, can be used to free up resources as well as promote more effective and efficient transmission.

### SUMMARY OF THE INVENTION

Accordingly, the present invention is directed to a method of configuring wireless resource for effective and efficient transmission in a wireless communication system that substantially obviates one or more problems due to limitations and disadvantages of the related art.

An object of the present invention is to provide a method of transmitting a data packet in a orthogonal frequency division multiplexing (OFDM) system.

Another object of the present invention is to provide a method of assigning wireless resources in an orthogonal frequency division multiplexing (OFDM) system,

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of transmitting a data packet in a orthogonal frequency division multiplexing (OFDM) system includes receiving feedback information from an access terminal (AT), configuring the data packet for indoor environment or outdoor environment with at least one of variable duration of cyclic prefix (CP) and of data portion and variable number of CPs based on the feedback

In another aspect of the present invention, a method of assigning wireless resources in an orthogonal frequency division multiplexing (OFDM) system includes configuring the wireless resources to correspond to a node tree, assigning a node to each user from the node tree, wherein the each user uses the assigned node along with at least one node stemming from the assigned node, and if at least one node is unassigned from the node tree, assigning the at least one unassigned node to at least one of regular data tone, guard tones, or pilot tones.

In a further aspect of the present invention, a method of assigning wireless resources in an orthogonal frequency division multiplexing (OFDM) system includes configuring the wireless resources to correspond to a node tree, assigning each wireless resource to a node of the node tree, wherein the node is a tile, if at least one tile is unused, assigning the at least one unassigned tile to at least one of regular data tone, guard tones, or pilot tones.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 is an exemplary diagram illustrating longer data symbol duration;

FIG. 2 is an exemplary diagram illustrating a super frame structure in FL and RL;

FIG. 3 is another exemplary diagram illustrating a super frame structure in FL and RL; and

FIG. 4 is an exemplary diagram illustrating a tree structure for resource allocation.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

In data transmission, the environment of a transmitter and/or a receiver can have influence the transmission. The environment can be classified into two categories—an indoor environment and an outdoor environment.

In an indoor environment, a delay spread in usually small, and the transmitter and/or the receiver is likely moving at a low speed or stationary. As a result, in this environment (e.g., indoor environment), a length of a cyclic prefix (CP) of an orthogonal frequency division multiplexing (OFDM) can be reduced in that narrower tone (or sub-carrier) can be used.

With shorter CP per symbol, energy used for the data transmission can be increased due to a smaller CP overhead. That is, a total fraction of time for the data transmission is further increased by using narrower OFDM tones, which results in longer data symbol duration.

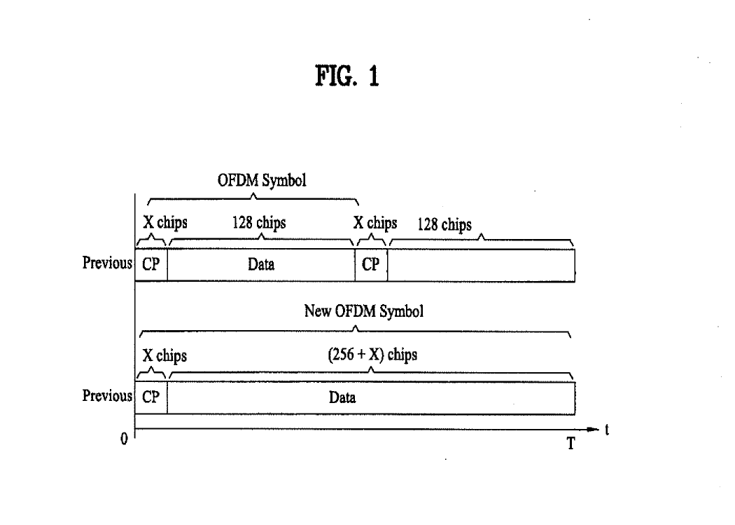

FIG. 1 is an exemplary diagram illustrating longer data symbol duration. Referring to FIG. 1, previous OFDM symbol has two (2) CPs, each having a length of x chips, followed by the data symbol having a length of 128 chips. In a new OFDM symbol, only one (1) CP having a length of x chips is present, followed by the data symbol having a length of 256 chips. Here, the previous OFDM symbol (or top symbol) can be viewed as a symbol design for the outdoor environment, and the new OFDM symbol (or bottom

In other words, the top OFDM symbols require two (2) CPs over the time duration of T, whereas the lower (new) OFDM symbol requires only one CP. This is an example in which the CP length has been chosen as ‘x’. Other CP lengths can be used which would vary the number or length of data chips. As for indoor environment, the CP length can be made smaller.

Furthermore, the example of FIG. 1 uses 128 chips for the data portion in the top (previous) OFVM symbol. However, other sample chip sizes can be used (e.g., 256 chips). In addition, the number of multiples need not be two (2) as is the case above. Other multiples can be used such as multiples of 3, 4, etc.

With mobility of the users, the users often move in and out of the outdoor environment to the indoor environment and vice versa. Typically in a cellular system, the OFDM numerologies are designed to optimize performance in the outdoor environment. As such, other set(s) of formats or OFDM numerologies can be designed to be more effective

Since a mobile (or a user) roams between an indoor and outdoor environments, the OFD)M symbol boundaries of indoor and outdoor formats can be aligned periodically, such that the frame/slot structure are synchronized for both environments. This approach can eliminate the delay for synchronization and acquisition of the target system when a mobile moves between two environments, This approach can also be useful to design a system which is suitable for both environments (e.g. different formats are used in different interlaces in a time division multiplexing fashion) to facilitate seamless transition between two environments.

For example, one interlace can be used for indoor and another interlace can be used for outdoor. In other words, the subpackets for indoor environment and outdoor environment are interlaced. This helps in the boundary region between indoor and outdoor cells. Further, the mix of interlaces (e.g., interlacing of indoor and outdoor) can be adaptive depending on the traffic requirements between indoor & outdoor users.

The embodiments of this invention describes a set of OFDM formats suitable for indoor use, whose symbol duration is multiple of the outdoor formats. The symbol boundaries of both formats are aligned periodically such that the same frame/slot structure can be used for both environments. Furthermore, one system can time multiplex both types of OFDM formats using a unified frame/slot structure.

A minimum fast Fourier transform (FFT) size corresponding to a sampling frequency greater than or equal to the system bandwidth can be used to transmit and/or receive the OFDM signal. For example, with 1.68 MHz based clock, FFT size of 1536 can be used in outdoor deployment (or outdoor environment) for the system bandwidth up to 20.16 MHz, instead of 2048 which is normally used for such system bandwidth. Other examples with different CP and tone spacing are discussed hereafter.

The discussions to follow relate to OFDM symbol design and numerologies associated with different symbol designs. For example, the design can be based on 1.2288 MHz and/or 1.68 MHz clock (or chip) rate for an outdoor environment. The formats for the outdoor environment can be based on conventional designs, and the formats for the indoor environments can have shorter CP with narrower tone (or sub-carrier) spacing. With this, there can be reduction in CP overhead. To put differently, the symbol duration can be twice the outdoor symbol duration with less CP overhead per slot/frame. Lastly, the slot/frame structure can be aligned for indoor and/or outdoor deployment (or environment).

The following tables illustrate various examples of OFDM symbol design numerologies for indoor and outdoor environments. The actual OFDM symbol design numerologies are not limited to the following examples but different numerologies can be implemented.

Table 1 illustrates an example of OFDM symbol design numerology for outdoor deployment (or environment). Here, the chip (or clock) rate is based on 1.2288 MHz.

TABLE 1

| | FFT size | | | |
|---|---|---|---|---|
| | 128 | 512 | 1024 | 2048 |
| Chip rate (MHz) | 1.2288 | 4.9152 | 9.8304 | 19.6608 |
| Subcarrier spacing (KHz) | 9.6 | | | |
| Bandwidth of operation (MHz) | 1.25 | >1.25 & ≦5 | >5 & ≦10 | >10 & ≦20 |

| | | |
|---|---|---|
| Guard carriers | 0 | Depends on the bandwidth |

| | |
|---|---|
| Cyclic prefix (μs) | 6.51, 13.02, 19.53, 26.04 |
| Window (μs) | 3.26 |
| OFDM symbol duration (μs) | 113.93, 120.44, 126.95, 133.46 |

Table 2 illustrates an example of a new OFDM symbol design numerology for indoor environment to be used with 6.51 μs CP outdoors with 1.2288 MHZ based clock.

TABLE 2

| | FFT size | | | |
|---|---|---|---|---|
| | 270 | 1080 | 2160 | 4320 |
| Chip rate (MHz) | 1.2288 | 4.9152 | 9.8304 | 19.6608 |
| Subcarrier spacing (KHz) | 4.55 | | | |
| Bandwidth of operation (MHz) | 1.25 | >1.25 & ≦5 | >5 & ≦10 | >10 & ≦20 |

| | | |
|---|---|---|
| Guard carriers | 0 | Depends on the bandwidth |

| | |
|---|---|
| Cyclic prefix (μs) | 4.88 |
| Window (μs) | 3.26 |
| OFDM symbol duration (μs) | 227.86 |

Table 3 illustrates an example of a new OFDM symbol design numerology for indoor environment to be used with 13.02 μs CP outdoors with 1.2288 MHz based clock.

TABLE 3

| | FFT size | | | |
|---|---|---|---|---|
| | 288 | 1152 | 2304 | 4608 |
| Chip rate (MHz) | 1.2288 | 4.9152 | 9.8304 | 19.6608 |
| Subcarrier spacing (KHz) | 4.27 | | | |
| Bandwidth of operation (MHz) | 1.25 | >1.25 & ≦5 | >5 & ≦10 | >10 & ≦20 |

| | | |
|---|---|---|
| Guard carriers | 0 | Depends on the bandwidth |

| | |
|---|---|
| Cyclic prefix (μs) | 3.26 |
| Window (μs) | 3.26 |
| OFDM symbol duration (μs) | 240.89 |

Table 4 illustrates an example of a new OFDM symbol design numerology for indoor environment to be used with 19.53 μs CP outdoors with 1.2288 MHz based clock.

TABLE 4

| | FFT size | | | |
|---|---|---|---|---|
| | 300 | 1200 | 2400 | 4800 |
| Chip rate (MHz) | 1.2288 | 4.9152 | 9.8304 | 19.6608 |
| Subcarrier spacing (KHz) | 4.1 | | | |
| Bandwidth of operation (MHz) | 1.25 | >1.25 & ≦5 | >5 & ≦10 | >10 & ≦20 |

| | | |
|---|---|---|
| Guard carriers | 0 | Depends on the bandwidth |

| | |
|---|---|
| Cyclic prefix (μs) | 6.51 |
| Window (μs) | 3.26 |
| OFDM symbol duration (μs) | 253.91 |

Table 5 illustrates an example of a new OFDM symbol design numerology for indoor environment to be used with 26.04 μs CP outdoors with 1.2288 MHz based clock.

TABLE 5

| | FFT size | | | |
|---|---|---|---|---|
| | 320 | 1280 | 2560 | 5120 |
| Chip rate (MHz) | 1.2288 | 4.9152 | 9.8304 | 19.6608 |
| Subcarrier spacing (KHz) | 3.84 | | | |
| Bandwidth of operation (MHz) | 1.25 | >1.25 & ≦5 | >5 & ≦10 | >10 & ≦20 |

| | | |
|---|---|---|
| Guard carriers | 0 | Depends on the bandwidth |

| | |
|---|---|
| Cyclic prefix (μs) | 3.26 |
| Window (μs) | 3.26 |
| OFDM symbol duration (μs) | 266.93 |

Table 6 illustrates an example of OFDM symbol design numerology for outdoor environment. Here, the chip rate is based on 1.68 MHz clock.

TABLE 6

| | FFT size | | | |
|---|---|---|---|---|
| | 128 | 512 | 1024 | 2048 |
| Chip rate (MHz) | 1.68 | 6.72 | 13.44 | 26.88 |
| Subcarrier spacing (KHz) | 13.125 | | | |
| Bandwidth of operation (MHz) | ≦1.68 | ≦1.68 & ≦6.72 | >6.72 & ≦13.44 | >13.44 & ≦20 |

| | |
|---|---|
| Useful tones | ≦the size of FFT depending on the bandwidth |
| Cyclic prefix + window (μs) | 7.14 |
| OFDM symbol duration (μs) | 83.33 |

Table 7 illustrates an example of a new OFDM symbol design numerology for indoor environment. Here, the chip rate is based on 1.68 MHz clock.

TABLE 7

| | FFT size | | | |
|---|---|---|---|---|
| | 270 | 1080 | 2160 | 4320 |
| Chip rate (MHz) | 1.68 | 6.72 | 13.44 | 26.88 |
| Subcarrier spacing (KHz) | 6.22 | | | |
| Bandwidth of operation (MHz) | ≦1.68 | >1.68 & ≦6.72 | >6.72 & ≦13.44 | >13.44 & ≦20 |

| | |
|---|---|
| Useful tones | ≦the size of FFT depending on the bandwidth |
| Cyclic prefix + window (μs) | 5.95 |
| OFDM symbol duration (μs) | 166.67 |

Table 8 illustrates an example of OFDM symbol design numerology for outdoor environment. Here, the chip rate is based on 1.2288 MHz clock.

TABLE 8

| | FFT size | | | | | |
|---|---|---|---|---|---|---|
| | 128 | 256 | 512 | 1024 | 1536 | 2048 |
| Chip rate (MHz) | 1.2288 | 2.4576 | 4.9152 | 9.8304 | 14.7456 | 19.6608 |
| Subcarrier spacing (KHz) | 9.6 | | | | | |
| Bandwidth of operation (MHz) | 1.25 | >1.25 & ≦2.5 | >2.5 & ≦5.0 | >5.0 & ≦10.0 | >10.0 & ≦15.0 | >15.0 & ≦20.0 |
| Guard carriers | Depends on the bandwidth | | | | | |
| Cyclic prefix + window (μs) | 12/9.77, | 24/9.77, | 48/9.77, | 96/9.77, | 144/9.77, | 192/9.77, |
| | 20/16.28, | 40/16.28, | 80/16.28, | 160/16.2, | 240/16.2, | 320/16.28, |
| | 28/22.79, | 56/22.79, | 112/22.79, | 224/22.79, | 336/22.7, | 448/22.79, |
| | 36/29.30 | 72/29.30 | 144/29.30 | 288/29.30 | 432/29.30 | 576/29.30 |
| OFDM symbol duration (μs) | 140/113.93, | 280/113.93, | 560/113.93, | 1120/113.93, | 1680/113.93, | 2240/113.93, |
| | 148/120.44, | 296/120.44, | 592/120.44, | 1184/120.44, | 1776/120.44, | 21368/120.44, |
| | 156/126.95, | 312/126.95, | 624/126.95, | 1248/126.95, | 1872/126.95, | 2496/126.95, |
| | 164/133.46 | 328/133.46 | 656/133.46 | 1312/133.46 | 1968/133.46 | 2624/133.46 |

Table 9 illustrates an example of OFDM symbol design numerology for indoors to be used with 9.77 μs CP+W outdoor environment with 1.2288 MHz based clock.

TABLE 9

| | FFT size | | | | | |
|---|---|---|---|---|---|---|
| | 270 | 540 | 1080 | 2160 | 3240 | 4320 |
| Chip rate (MHz) | 1.2288 | 2.4576 | 4.9152 | 9.8304 | 14.7456 | 19.6608 |
| Subcarrier spacing (KHz) | 4.55 | | | | | |
| Bandwidth of operation (MHz) | 1.25 | >1.25 & ≦2.5 | >2.5 & ≦5.0 | >5.0 & ≦10.0 | >10.0 & ≦15.0 | >15.0 & ≦20.0 |
| Guard carriers | Depends on the bandwidth | | | | | |
| Cyclic prefix + window (μs) | 10/8.14 | 20/8.14 | 40/8.14 | 80/8.14 | 120/8.14 | 160/8.14 |
| OFDM symbol duration (μs) | 280/227.89 | 560/227.89 | 1120/227.89 | 2240/227.89 | 3360/227.89 | 4480/227.89 |

Table 10 illustrates an example of OFDM symbol design numerology for indoors to be used with 16.28 μs CP+W outdoor environment with 1.2288 MHz based clock.

TABLE 10

| | FFT size | | | | | |
|---|---|---|---|---|---|---|
| | 288 | 576 | 1152 | 2304 | 3456 | 4608 |
| Chip rate (MHz) | 1.2288 | 2.4576 | 4.9152 | 9.8304 | 14.7456 | 19.6608 |
| Subcarrier spacing (KHz) | 4.27 | | | | | |
| Bandwidth of operation (MHz) | 1.25 | >1.25 & ≦2.5 | >2.5 & ≦5.0 | >5.0 & ≦10.0 | >10.0 & ≦15.0 | >15.0 & ≦20.0 |
| Guard carriers | Depends on the bandwidth | | | | | |
| Cyclic prefix + window (μs) | 8/6.51 | 16/6.51 | 32/6.51 | 64/6.51 | 96/6.51 | 128/6.51 |
| OFDM symbol duration (μs) | 296/240.86 | 592/240.86 | 1184/240.86 | 2368/240.86 | 3552/240.86 | 4736/240.86 |

Table 11 illustrates an example of O)FDM symbol design numerology for indoors to be used with 22.79 μs CP+W outdoor environment with 1.2288 MHz based clock.

TABLE 11

| | FFT size | | | | | |
|---|---|---|---|---|---|---|
| | 300 | 600 | 1200 | 2400 | 3600 | 4800 |
| Chip rate (MHz) | 1.2288 | 2.4576 | 4.9152 | 9.8304 | 14.7456 | 19.6608 |
| Subcarrier spacing (KHz) | 4.10 | | | | | |
| Bandwidth of operation (MHz) | 1.25 | >1.25 & ≦2.5 | >2.5 & ≦5.0 | >5.0 &≦10.0 | >10.0 & ≦15.0 | >15.0 & ≦20.0 |
| Guard carriers | Depends on the bandwidth | | | | | |
| Cyclic prefix + window (μs) | 12/9.77 | 24/9.77 | 48/9.77 | 96/9.77 | 144/9.77 | 192/9.77 |
| OFDM symbol duration (μs) | 312/253.91 | 624/253.91 | 1248/253.91 | 2496/253.91 | 3744/253.91 | 4992/253.91 |

Table 12 illustrates an example of OFDM symbol design numerology for indoors to be used with 29.30 μs CP+W outdoor environment with 1.2288 MHz based clock.

TABLE 12

| | FFT size | | | | | |
|---|---|---|---|---|---|---|
| | 320 | 640 | 1280 | 2560 | 3840 | 5120 |
| Chip rate (MHz) | 1.2288 | 2.4576 | 4.9152 | 9.8304 | 14.7456 | 19.6608 |
| Subcarrier spacing (KHz) | 3.84 | | | | | |
| Bandwidth of operation (MHz) | 1.25 | >1.25 & ≦2.5 | >2.5 & ≦5.0 | >5.0 & ≦10.0 | >10.0 & ≦15.0 | >15.0 & ≦20.0 |
| Guard carriers | Depends on the bandwidth | | | | | |
| Cyclic prefix + window (μs) | 8/6.51 | 16/6.51 | 32/6.51 | 64/6.51 | 96/6.51 | 128/6.51 |
| OFDM symbol duration (μs) | 328/266.93 | 656/266.93 | 1312/266.93 | 2624/266.93 | 3936/266.93 | 5248/266.93 |

Table 13 illustrates an example of OFDM symbol design numerology for outdoor environment. Here, the chip rate is based on 1.68 MHz clock.

TABLE 13

| | FFT size | | | | |
|---|---|---|---|---|---|
| | 128 | 256 | 512 | 1024 | 1536 |
| Chip rate (MHz) | 1.68 | 3.36 | 6.72 | 13.44 | 20.16 |
| Subcarrier spacing (KHz) | 13.125 | | | | |
| Bandwidth of operation (MHz) | ≦1.68 | >1.68 & ≦6.72 | >3.36 & ≦6.72 | >6.72 & ≦13.44 | >13.44 & ≦20.16 |
| Guard carriers | Depends on the bandwidth | | | | |
| Cyclic prefix + window (μs) | 12/7.14, | 24/7.14, | 48/7.14, | 96/7.14, | 144/7.14, |
| | 20/11.90, | 40/11.90, | 80/11.90, | 160/11.90, | 240/11.90, |
| | 28/16.67, | 56/16.67, | 112/16.67, | 224/16.67, | 336/16.67, |
| | 36/21.43 | 72/21.43 | 144/21.43 | 288/21.43 | 432/21.43 |
| OFDM symbol duration (μs) | 140/83.33, | 280/83.33, | 560/83.33, | 1120/83.33, | 1680/83.33, |
| | 148/88.10, | 296/88.10, | 592/88.10, | 1184/88.10, | 1776/88.10, |
| | 156/92.86, | 312/92.86, | 624/92.86, | 1248/92.86, | 1872/92.86, |
| | 164/97.62 | 328/97.62 | 656/97.62 | 1312/97.62 | 1968/97.62 |

Table 14 illustrates an example of OFDM symbol design numerology for indoor environment to be used with 7.14 μs CP+W outdoors with 1.68 MHz based clock.

TABLE 14

| | FFT size | | | | |
|---|---|---|---|---|---|
| | 270 | 540 | 1080 | 2160 | 3240 |
| Chip rate (MHz) | 1.68 | 3.36 | 6.72 | 13.44 | 20.16 |
| Subcarrier spacing (KHz) | 6.22 | | | | |
| Bandwidth of operation (MHz) | ≦1.68 | >1.68 & ≦6.72 | >3.36 & ≦6.72 | >6.72 & ≦13.44 | >13.44 & ≦20.16 |
| Guard carriers | Depends on the bandwidth | | | | |
| Cyclic prefix + window (μs) | 10/5.95 | 20/5.95 | 40/5.95 | 80/5.95 | 120/5.95 |
| OFDM symbol duration (μs) | 280/166.67 | 560/166.67 | 1120/166.67 | 2240/166.67 | 3360/166.67 |

Table 15 illustrates an example of OFDM symbol design numerology for indoor environment to be used with 11.90 μs CP+W outdoors with 1.68 MHz based clock.

TABLE 15

| | FFT size | | | | |
|---|---|---|---|---|---|
| | 288 | 576 | 1152 | 2304 | 3456 |
| Chip rate (MHz) | 1.68 | 3.36 | 6.72 | 13.44 | 20.16 |
| Subcarrier spacing (KHz) | 5.83 | | | | |
| Bandwidth of operation (MHz) | ≦1.68 | >1.68 & ≦6.72 | >3.36 & ≦6.72 | >6.72 & ≦13.44 | >13.44 & ≦20.16 |
| Guard carriers | Depends on the bandwidth | | | | |
| Cyclic prefix + window (μs) | 8/4.76 | 16/4.76 | 32/4.76 | 64/4.76 | 96/4.76 |
| OFDM symbol duration (μs) | 296/176.19 | 592/176.19 | 1184/176.19 | 2368/176.19 | 3552/176.19 |

Table 16 illustrates an example of OFDM symbol design numerology for indoor environment to be used with 16.67 μs CP+W outdoors with 1.68 MHz based clock.

TABLE 16

| | FFT size | | | | |
|---|---|---|---|---|---|
| | 300 | 600 | 1200 | 2400 | 3600 |
| Chip rate (MHz) | 1.68 | 3.36 | 6.72 | 13.44 | 20.16 |
| Subcarrier spacing (KHz) | 5.6 | | | | |
| Bandwidth of operation (MHz) | ≦1.68 | ≦1.68 & ≦6.72 | >3.36 & ≦6.72 | >6.72 & ≦13.44 | >13.44 & ≦20.16 |
| Guard carriers | Depends on the bandwidth | | | | |
| Cyclic prefix + window (μs) | 12/7.14 | 24/7.14 | 48/7.14 | 96/7.14 | 144/7.14 |
| OFDM symbol duration (μs) | 312/185.71 | 624/185.71 | 1248/185.71 | 2496/185.71 | 3744/185.71 |

Table 17 illustrates an example of OFDM symbol design numerology for indoor environment to be used with 21.43 μs CP+W outdoors with 1.68 MHz based clock.

TABLE 17

| | FFT size | | | | |
|---|---|---|---|---|---|
| | 320 | 640 | 1280 | 2560 | 3840 |
| Chip rate (MHz) | 1.68 | 3.36 | 6.72 | 13.44 | 20.16 |
| Subcarrier spacing (KHz) | 5.25 | | | | |
| Bandwidth of operation (MHz) | ≦1.68 | >1.68 & ≦6.72 | >3.36 & ≦6.72 | >6.72 & ≦13.44 | >13.44 & ≦20.16 |
| Guard carriers | Depends on the bandwidth | | | | |
| Cyclic prefix + window (μs) | 8/4.76 | 16/4.76 | 32/4.76 | 64/4.76 | 96/4.76 |
| OFDM symbol duration (μs) | 328/195.24 | 656/195.24 | 1312/195.24 | 2624/195.24 | 3936/195.24 |

Although the discussed formats are primarily intended for indoor environments, but they can also be applied to any environments in which the delay spread is smaller than CP duration and low mobility.

As discussed, various numerologies can be applied to indoor and outdoor environments. In operation, the numerology can be configured by the location of a base station (or the network). More specifically, the base station (BS) or the network can first determine whether an indoor or outdoor symbol numerology based on channel quality information (CQI) and/or sector information (e.g., CQI cover) from an access terminal (AT).

If the BS or the network determines that the AT is located in an indoor environment based on the CQI, then the BS (or the network) instructs the AT to use an indoor numerology for a forward link (FL). In other words, the BS transmits data using the indoor numerology.

Likewise, if the BS determines that the AT is located in an indoor environment based on the CQI, then the BS (or the network) instructs the AT to use an indoor numerology for a reverse link (RL). In other words, the BS instructs the AT to use the indoor numerology in sending data to the BS.

Similarly, if the BS or the network determines that the AT is located in an outdoor environment based on the CQI, then the BS (or the network) instructs the AT to use an outdoor numerology for a forward link (FL). In other words, the BS transmits data using

Likewise, if the BS determines that the AT is located in an outdoor environment based on the CQI, then the BS (or the network) instructs the AT to use an outdoor numerology for a reverse link (RL). In other words, the BS instructs the AT to use the outdoor numerology in sending data to the BS.

In application of the indoor or outdoor numerology, which indicates that the AT is either indoor or outdoor, it is possible for the AT to move from one location to another. That is, the AT can move from indoor environment to an outdoor environment or vice versa. In such a case, a handoff (or handover) can occur between the environments.

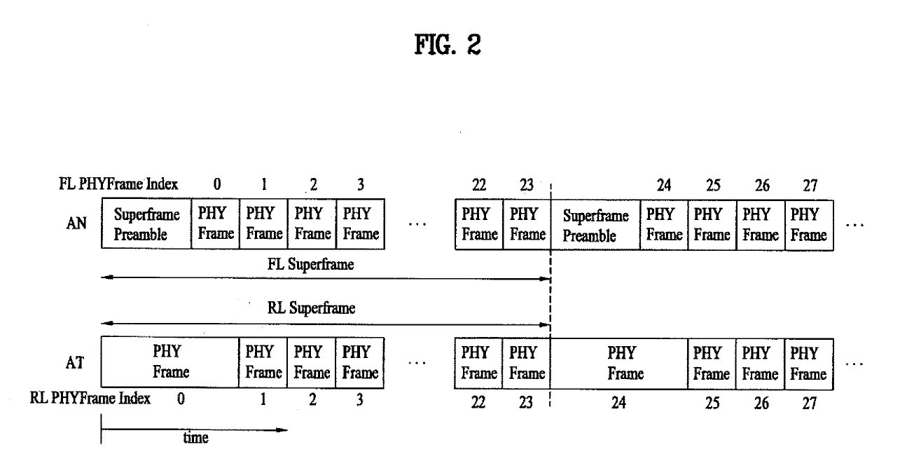

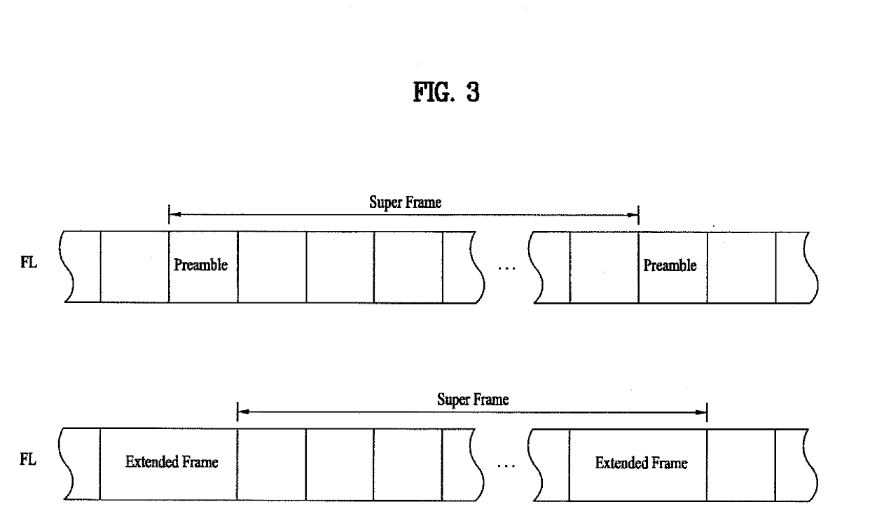

As discussed, in transmitting an indication to the AT from the BS (or the network) to either use the indoor or outdoor numerology, a super frame preamble can be used, The super frame consists of 25 physical frames and a preamble. Each physical frame consists of 8 OFOM symbols (e.g., 8×113.93 us (6.51 us CP) 911.44 us). Moreover, the preamble contains 8 OFDM symbols. Furthermore, a first RL physical frame is elongated top align FL and RL transmissions. FIG. 2 is an exemplary diagram illustrating a super frame structure in FL and RL. FIG. 3 is another exemplary diagram illustrating a super frame structure in FL and RL.

For indoor and outdoor operations implementation, some physical frames can be assigned for indoor operation. This information can be included in the super frame preamble. The physical frames assigned for the indoor environment have reduced CP duration and/or different numerologies.

Further, there can be two (2) super frame structures—one for indoor environment and the other for outdoor environment. Here, the super frame may align with each other. Both frame structures can share a common super-frame preamble for reliable acquisition, but may have different physical frames with reduced CP duration and/or different numerologies.

In OFDM systems, some portions of time and frequency resources can be assigned to each other. In order to assign those some portions of time and frequency resources and to facilitate efficient resource allocation, all the resources can be partitioned into a plurality of blocks (or tiles). That is, the plurality of blocks (or tiles) can be assigned to each other.

Typically, a block or a tile is comprised of 16 subcarriers and eight (8) symbols (e.g., OFDM symbols). The block (or tile) can be further divided into sub-tiles.

Tables 18-21 are examples of tile design having fixed 32 tones (or subcarriers) per tile. By having fixed number of tones per tile, a unified number of tones per tile (e.g., 128 tones/tile) can be presented regardless of a different subcarrier spacing and CP (Cyclic Prefix)+W (Windowing Time). That is, the same resource partitioning schemes can be made available for all the cases.

Table 18 illustrates an example of a tile design for subcarrier spacing of 4.55 kHz with fixed 32 tones per tile.

TABLE 18

| Indoor | | Subcarrier | | | | | | Tile | | # of extra | # of |
|---|---|---|---|---|---|---|---|---|---|---|---|
| CP + W | | spacing | # of | # of | Tot | Tile X | Tile Y | Tones | # of | tiles in terms | leftover |
| [micro-sec] | BW [MHz] | [kHz] | tones | sym | tones | [Symbol] | [Tones] | [X*Y] | Tiles | of 2ⁿ | tones |
| 8.14 | 1.25 | 4.55 | 270 | 4 | 1080 | 4 | 32 | 128 | 8.4375 | 0 | 14 |
| | 1.25 to 2.5 | 4.55 | 540 | 4 | 2160 | 4 | 32 | 128 | 16.875 | 0 | 28 |
| | 2.5 to 5 | 4.55 | 1080 | 4 | 4320 | 4 | 32 | 128 | 33.75 | 1 | 24 |
| | 5 to 10 | 4.55 | 2160 | 4 | 8640 | 4 | 32 | 128 | 67.5 | 3 | 16 |
| | 10 to 15 | 4.55 | 3240 | 4 | 12960 | 4 | 32 | 128 | 101.25 | 5 | 8 |
| | 15 to 20 | 4.55 | 4320 | 4 | 17280 | 4 | 32 | 128 | 135 | 7 | 0 |

Table 19 illustrates an example of a tile design for subcarrier spacing of 4.27 kHz with fixed 32 tones per tile,

TABLE 19

| Indoor | | Subcarrier | | | | | | Tile | | # of extra | # of |
|---|---|---|---|---|---|---|---|---|---|---|---|
| CP + W | | spacing | # of | # of | Tot | Tile X | Tile Y | Tones | # of | tiles in terms | leftover |
| [micro-sec] | BW [MHz] | [kHz] | tones | sym | tones | [Symbol] | [Tones] | [X*Y] | Tiles | of 2ⁿ | tones |
| 6.51 | 1.25 | 4.27 | 288 | 4 | 1152 | 4 | 32 | 128 | 9 | 1 | 0 |
| | 1.25 to 2.5 | 4.27 | 576 | 4 | 2304 | 4 | 32 | 128 | 18 | 2 | 0 |
| | 2.5 to 5 | 4.27 | 1152 | 4 | 4608 | 4 | 32 | 128 | 36 | 4 | 0 |
| | 5 to 10 | 4.27 | 2304 | 4 | 9216 | 4 | 32 | 128 | 72 | 8 | 0 |
| | 10 to 15 | 4.27 | 3456 | 4 | 13824 | 4 | 32 | 128 | 108 | 12 | 0 |
| | 15 to 20 | 4.27 | 4608 | 4 | 18432 | 4 | 32 | 128 | 144 | 16 | 0 |

Table 20 illustrates an example of a tile design for subcarrier spacing of 4.1 kHz with fixed 32 tones per tile.

TABLE 20

| Indoor | | Subcarrier | | | | | | Tile | | # of extra | # of |
|---|---|---|---|---|---|---|---|---|---|---|---|
| CP + W | | spacing | # of | # of | Tot | Tile X | Tile Y | Tones | # of | tiles in terms | leftover |
| [micro-sec] | BW [MHz] | [kHz] | tones | sym | tones | [Symbol] | [Tones] | [X*Y] | Tiles | of 2ⁿ | tones |
| 9.77 | 1.25 | 4.1 | 300 | 4 | 1200 | 4 | 32 | 128 | 9.375 | 1 | 12 |
| | 1.25 to 2.5 | 4.1 | 600 | 4 | 2400 | 4 | 32 | 128 | 18.75 | 2 | 24 |
| | 2.5 to 5 | 4.1 | 1200 | 4 | 4800 | 4 | 32 | 128 | 37.5 | 5 | 16 |
| | 5 to 10 | 4.1 | 2400 | 4 | 9600 | 4 | 32 | 128 | 75 | 11 | 0 |
| | 10 to 15 | 4.1 | 3600 | 4 | 14400 | 4 | 32 | 128 | 112.5 | 16 | 16 |
| | 15 to 20 | 4.1 | 4800 | 4 | 19200 | 4 | 32 | 128 | 150 | 22 | 0 |

Table 21 illustrates an example of a tile design for subcarrier spacing of 3.84 kHz with fixed 32 tones per tile.

TABLE 21

| Indoor | | Subcarrier | | | | | | Tile | | # of extra | # of |
|---|---|---|---|---|---|---|---|---|---|---|---|
| CP + W | | spacing | # of | # of | Tot | Tile X | Tile Y | Tones | # of | tiles in terms | leftover |
| [micro-sec] | BW [MHz] | [kHz] | tones | sym | tones | [Symbol] | [Tones] | [X*Y] | Tiles | of 2ⁿ | tones |
| 6.51 | 1.25 | 3.84 | 320 | 4 | 1280 | 4 | 32 | 128 | 10 | 2 | 0 |
| | 1.25 to 2.5 | 3.84 | 640 | 4 | 2560 | 4 | 32 | 128 | 20 | 4 | 0 |
| | 2.5 to 5 | 3.84 | 1260 | 4 | 5120 | 4 | 32 | 128 | 40 | 8 | 0 |
| | 5 to 10 | 3.84 | 2560 | 4 | 10240 | 4 | 32 | 128 | 80 | 16 | 0 |
| | 10 to 15 | 3.84 | 3840 | 4 | 15360 | 4 | 32 | 128 | 120 | 24 | 0 |
| | 15 to 20 | 3.84 | 5120 | 4 | 20480 | 4 | 32 | 128 | 160 | 32 | 0 |

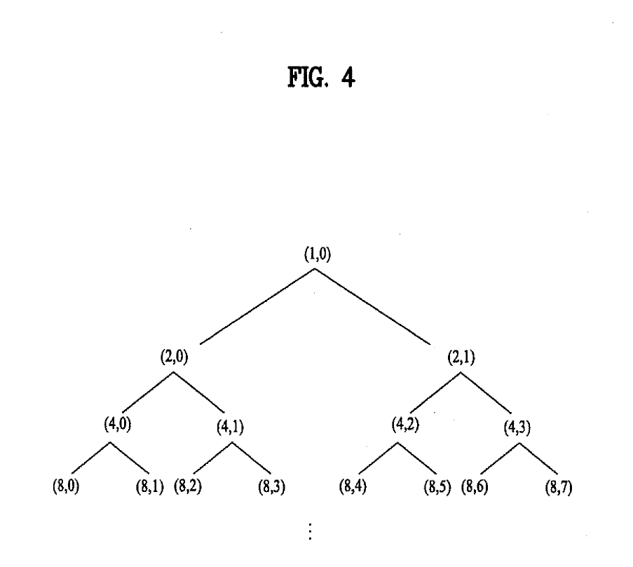

Further, each time can be assigned to users as binary tree nodes as illustrated in FIG. 4. FIG. 4 is an exemplary diagram illustrating a tree structure for resource allocation.

Referring to FIG. 4, nodes ((8,0)˜(8,7)) represent tiles with respect to Table 17 with a bandwidth of 1.25 MHz. A node can be assigned in various ways. For example, one node can be assigned to one user, any arbitrary number of nodes can be assigned to each user, or a junk of nodes (i.e., (4,1) or (2,1) or (1,0)) can be assigned to one user. Here, (4,1) means 2 consecutive tiles ((8,2) and (8,3)), (2,1) means 4 consecutive tiles ((8,4)˜(8,7)), and (1,0) means all 8 tiles in 1.25 MHz is assigned to one user.

Further, any types of tree structures can be used to satisfy the total number of tiles in a given time and frequency resources. In other words, other types of tree structures can also be used to achieve the same purpose. As discussed, FIG. 4 is an example of a tree structure (e.g., binary node tree).

If a binary tree structure of above (or any other tree structures) is used for resource allocation, there can be extra (or leftover) tiles and/or extra (or leftover) tones. This is shown in the last two (2) columns (labeled “# of extra tiles” and “# of leftover tones”) of FIGS. 18-21.

These extra (or leftover) tiles and/or tones can be utilized as regular data tones, guard tones, or pilot tones. In particular, the extra (or leftover) tones can be used as pilot tones that can be inserted between the tiles.

Based on the tiles designs as shown in FIGS. 18-21, additional tile designs can be implemented. These tile designs are focused towards reducing the extra (or leftover) tiles by way of controlling or adjusting the tile sizes.

FIGS. 22-25 are examples of tile designs having a different number of tones per tile. By having different number of tones per tile, the number of extra (or leftover) tiles can be reduced, promoting more efficient resource allocation.

Table 22 illustrates an example of a tile design for subcarrier spacing of 4.55 kHz with fixed 33 tones per tile.

TABLE 22

| Indoor | | Subcarrier | | | | | | Tile | | # of extra | # of |
|---|---|---|---|---|---|---|---|---|---|---|---|
| CP + W | | spacing | # of | # of | Tot | Tile X | Tile Y | Tones | # of | tiles in terms | leftover |
| [micro-sec] | BW [MHz] | [kHz] | tones | sym | tones | [Symbol] | [Tones] | [X*Y] | Tiles | of 2ⁿ | tones |
| 8.14 | 1.25 | 4.55 | 270 | 4 | 1080 | 4 | 33 | 132 | 8.182 | 0 | 6 |
| | 1.25 to 2.5 | 4.55 | 540 | 4 | 2160 | 4 | 33 | 132 | 16.36 | 0 | 12 |
| | 2.5 to 5 | 4.55 | 1080 | 4 | 4320 | 4 | 33 | 132 | 32.73 | 0 | 24 |
| | 5 to 10 | 4.55 | 2160 | 4 | 8640 | 4 | 33 | 132 | 65.45 | 1 | 15 |
| | 10 to 15 | 4.55 | 3240 | 4 | 12960 | 4 | 33 | 132 | 98.18 | 2 | 6 |
| | 15 to 20 | 4.55 | 4320 | 4 | 17280 | 4 | 33 | 132 | 130.9 | 2 | 30 |

Table 23 illustrates an example of a tile design for subcarrier spacing of 4.27 kHz with fixed 36 tones per tile.

TABLE 23

| Indoor | | Subcarrier | | | | | | Tile | | # of extra | # of |
|---|---|---|---|---|---|---|---|---|---|---|---|
| CP + W | | spacing | # of | # of | Tot | Tile X | Tile Y | Tones | # of | tiles in terms | leftover |
| [micro-sec] | BW [MHz] | [kHz] | tones | sym | tones | [Symbol] | [Tones] | [X*Y] | Tiles | of 2ⁿ | tones |
| 6.51 | 1.25 | 4.27 | 288 | 4 | 1152 | 4 | 36 | 144 | 8 | 0 | 0 |
| | 1.25 to 2.5 | 4.27 | 576 | 4 | 2304 | 4 | 36 | 144 | 16 | 0 | 0 |
| | 2.5 to 5 | 4.27 | 1152 | 4 | 4608 | 4 | 36 | 144 | 32 | 0 | 0 |
| | 5 to 10 | 4.27 | 2304 | 4 | 9216 | 4 | 36 | 144 | 64 | 0 | 0 |
| | 10 to 15 | 4.27 | 3456 | 4 | 13824 | 4 | 36 | 144 | 96 | 0 | 0 |
| | 15 to 20 | 4.27 | 4608 | 4 | 18432 | 4 | 36 | 144 | 128 | 0 | 0 |

Table 24 illustrates an example of a tile design for subcarrier spacing of 4.1 kHz with fixed 37 tones per tile.

TABLE 24

| Indoor | | Subcarrier | | | | | | Tile | | # of extra | # of |
|---|---|---|---|---|---|---|---|---|---|---|---|
| CP + W | | spacing | # of | # of | Tot | Tile X | Tile Y | Tones | # of | tiles in terms | leftover |
| [micro-sec] | BW [MHz] | [kHz] | tones | sym | tones | [Symbol] | [Tones] | [X*Y] | Tiles | of 2ⁿ | tones |
| 9.77 | 1.25 | 4.1 | 300 | 4 | 1200 | 4 | 37 | 148 | 8.108 | 0 | 4 |
| | 1.25 to 2.5 | 4.1 | 600 | 4 | 2400 | 4 | 37 | 148 | 16.22 | 0 | 8 |
| | 2.5 to 5 | 4.1 | 1200 | 4 | 4800 | 4 | 37 | 148 | 32.43 | 0 | 16 |
| | 5 to 10 | 4.1 | 2400 | 4 | 9600 | 4 | 37 | 148 | 64.86 | 0 | 32 |
| | 10 to 15 | 4.1 | 3600 | 4 | 14400 | 4 | 37 | 148 | 97.3 | 1 | 11 |
| | 15 to 20 | 4.1 | 4600 | 4 | 19200 | 4 | 37 | 148 | 129.7 | 1 | 27 |

Table 25 illustrates an example of a tile design for subcarrier spacing of 3.84 kHz with fixed 40 tones per tile.

TABLE 25

| Indoor | | Subcarrier | | | | | | Tile | | # of extra | # of |
|---|---|---|---|---|---|---|---|---|---|---|---|
| CP + W | | spacing | # of | # of | Tot | Tile X | Tile Y | Tones | # of | tiles in terms | leftover |
| [micro-sec] | BW [MHz] | [kHz] | tones | sym | tones | [Symbol] | [Tones] | [X*Y] | Tiles | of 2ⁿ | tones |
| 6.51 | 1.25 | 3.84 | 320 | 4 | 1280 | 4 | 40 | 160 | 8 | 0 | 0 |
| | 1.25 to 2.5 | 3.84 | 640 | 4 | 2560 | 4 | 40 | 160 | 16 | 0 | 0 |
| | 2.5 to 5 | 3.84 | 1280 | 4 | 5120 | 4 | 40 | 160 | 32 | 0 | 0 |
| | 5 to 10 | 3.84 | 2560 | 4 | 10240 | 4 | 40 | 160 | 64 | 0 | 0 |
| | 10 to 15 | 3.84 | 3840 | 4 | 15360 | 4 | 40 | 160 | 96 | 0 | 0 |
| | 15 to 20 | 3.84 | 5120 | 4 | 20480 | 4 | 40 | 160 | 128 | 0 | 0 |

As shown by the tables, depending on the bandwidth and/or tone spacing, extra (or leftover) tiles can arise. A small number of extra or leftover tiles (e.g., 1 or 2 tiles) can be used as guard tones, for example. Typically, two (2) tiles are used for guard tones in 5 MHz bandwidth. Alternatively, the extra or leftover tiles can be used for data tones and/or pilot tones. These extra or leftover tones can also be used in the same way as regular data tones, guard tones, or pilot tones that can be inserted between tiles.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of transmitting a data packet in a orthogonal frequency division multiplexing (OFDM) system, the method comprising:
receiving feedback information from an access terminal (AT);
configuring the data packet for indoor environment or outdoor environment with at least one of variable duration of cyclic prefix (CP) and of data portion and variable number of CPs based on the feedback information; and
transmitting the configured data packet to the AT.

2. The method of claim 1, wherein the feedback information is at least one of channel quality information and sector information.

3. The method of claim 1, wherein the data packet signifies a plurality of physical frames and a preamble.

4. The method of claim 3, wherein the preamble indicates whether the data packet is for the indoor environment or the outdoor environment.

5. The method of claim 1, wherein the data packet for a reverse link and a forward link are aligned periodically.

6. The method of claim 1, wherein the configured data packet represents a time multiplexed format of the indoor and the outdoor environments.

7. The method of claim 1, wherein the configured data packet has a chip rate of 1.2288 MHz or 1.68 MHz and multiples thereof.

8. The method of claim 1, wherein the configured data packet for the indoor environment has shorter CP with narrower tone spacing than that of the outdoor environment.

9. A method of assigning wireless resources in an orthogonal frequency division multiplexing (OFDM) system, the method comprising:
configuring the wireless resources to correspond to a node tree;
assigning a node to each user from the node tree, wherein the each user uses the assigned node along with at least one node stemming from the assigned node; and
if at least one node is unassigned from the node tree, assigning the at least one unassigned node to at least one of regular data tone, guard tones, or pilot tones.

10. The method of claim 9, wherein the wireless resources are tiles.

11. The method of claim 10, wherein the tile is comprised of 16 sub-carriers and 8 OFDM symbols.

12. The method of claim 10, wherein the tile has configurable number of sub-carriers and OFDM symbols.

13. The method of claim 12, wherein the tile is comprised of at least 32 sub-carriers and at least four OFDM symbols.

14. The method of claim 9, wherein the OFDM system has variable sub-carrier spacing and cyclic prefix.

15. The method of claim 9, wherein the node tree is a binary node tree.

16. A method of assigning wireless resources in an orthogonal frequency division multiplexing (OFDM) system, the method comprising.
configuring the wireless resources to correspond to a node tree;
assigning each wireless resource to a node of the node tree, wherein the node is a tile;
if at least one tile is unused, assigning the at least one unassigned tile to at least one of regular data tone, guard tones, or pilot tones.

17. The method of claim 16, wherein the tile is configurable.

18. The method of claim 17, wherein the tile is comprised of at least 32 sub-carriers and at least four OFDM symbols.

19. The method of claim 16, wherein the unused tiles is used as pilot tones that are inserted between tiles.

20. The method of claim 16, wherein the node tree is a binary node tree.
